(19) United States
(12) Patent Application Publication
(10) Pub. No.: US 2006/0156394 A1
(43) Pub. Date: Jul. 13, 2006

(54) Signature creation device

(75) Inventor: Lukasz Wlodarczyk, Paris (FR)

Correspondence Address: OSHA LIANG L.L.P., 1221 MCKINNEY STREET, SUITE 2800, HOUSTON, TX, 77010, US

(73) Assignee: AXALTO SA, Montrouge (FR)

(21) Appl. No.: 10/530,510

(22) PCT Filed: Oct. 7, 2003
(86) PCT No.: PCT/IB03/04402

§ 371 Date: Sep. 7, 2005

(30) Foreign Application Priority Data
Oct. 7, 2002 (EP) 022924724
Jul. 7, 2003 (EP) 032916876

(51) Int. Cl. H04L 9/32

(52) U.S. Cl. 726/9

(57) ABSTRACT

A signature creation device comprises a signature module arranged to sign data. The signature creation device further comprises a parser module arranged to check the data against rules. The rules are stored on the signature creation device.

### FIELD OF THE INVENTION

The invention concerns signature creation devices (SCDs), in particular smartcards, for example, in the form of a corporate badge. The invention concerns in particular secure signature creation devices (SSCDs) as defined in the Directive 1993/93 EC of the European Parliament. A SSCD can be, for example, a PKI (Public Key Infrastructure) smartcard. The data to be signed can be, for example, a text document, an application, an image, an MP3 music, an MPEG movie or whatever else.

### BACKGROUND OF THE INVENTION

Generally a signature creation device, for example, a PKI smartcard, is arranged to be connected to a personal computer (PC). A user may want to sign, for example, a purchase order that has been written on the PC. To sign the email, the user sends the purchase order to the PKI smartcard, which is arranged to sign the purchase order.

### SUMMARY OF THE INVENTION

It is an object of the invention to compute an electronic signature with an enhanced security.

According to one aspect of the invention, a signature creation device comprising a signature module arranged to sign data, is characterized in that the signature creation device comprises a parser module arranged to check the data against rules, the rules being stored on the signature creation device.

The signature creation device can be, for example, a PKI smartcard arranged to be inserted in a personal computer (PC). The data to be signed can be, for example, a document like a purchase order or a contract. The document is sent from the PC, to be signed in the PKI smartcard.

As a matter of a fact, a PC is insecure by nature. A virus can indeed intercept and modify the data to be signed before transmitting to the PKI smartcard. Consequently, what is seen on the screen of a PC (or more generally what is perceived through the peripherals that are installed on a PC, such as sound cards etc.) is not necessarily what is sent to the PKI smartcard. Therefore, a user don't necessarily sign what he think he sign, no matter how secure is the PKI smartcard. In addition, as explained in the following example, the data to be signed can sometimes be formatted in such a manner that it is displayed differently before and after you signed it:

Example—Rogue document format

Attack Basics: Alice and Bob want to sign a contract saying that Alice will pay Bob $100. Alice types it up as a Word document and both digitally sign it. In a few days Bob comes to Alice to collect his money. To his surprise, Alice presents him with a Word document that states he owes her $100. Alice also has a valid signature from Bob for the new document. In fact, it is the exact same signature as for the contract Bob remembers signing and, to Bob's great amazement, the two Word documents are actually identical in hex.

What Alice did was insert an IF field that branched on an external input such as date or file name. Thus even though the signed contents remained the same, the displayed contents changed because they were partially dependent on unsigned inputs. The basic point is that very few users know the actual contents of their Word documents and it should be obvious that one should never sign what one cannot read. Of course, Bob could contest the contract in court.

Proof of concept: Inserting the following field structure at the tail of the document will cause “Hello” to be displayed if the filename is “a.doc” and

“Bye” otherwise. { IF { FILENAME \* MERGEFORMAT
{ DATE } } = “a.doc” “Hello” “Bye” \* MERGEFORMAT }

With the invention, the contract is checked against rules within the PKI smartcard itself. The rules can advantageously define a security policy. Therefore, if the contract has been modified and thus does not meet the security policy any more, the PKI smartcard is informed. In this case, the PKI smartcard can be arranged not to sign the contract. An electronic signature can thus be computed with an enhanced security.

### BRIEF SUMMARY OF THE DRAWINGS

FIG. 1 illustrates a signature creation device;

FIG. 2 illustrates a fund transfer form;

FIG. 3 illustrates a signature module comprising a hashing module and a padding module.

### DETAILED DESCRIPTION

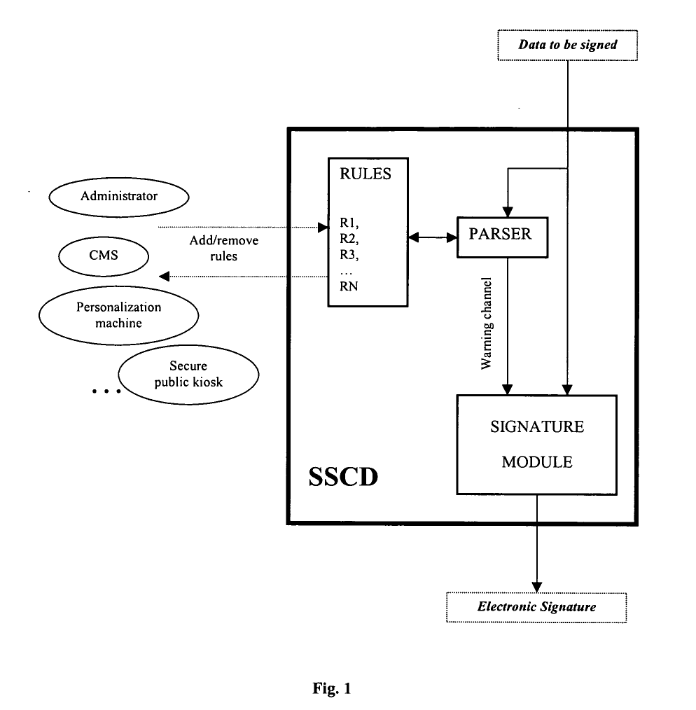

FIG. 1 illustrates a signature creation device comprising a signature module arranged to sign data and a parser module arranged to check the data against parsing rules that are stored on the signature creation device. The data to be signed can be, for example, in an ASCII format or in any other format. The signature creation device can be, for example, a smartcard comprising an integrated circuit provided with a central process unit (CPU). The integrated circuit is, for example, a chip of the ST22 family. The integrated circuit comprises advantageously a customized logic (i.e SPTLA) and configuration. Advantageously, the integrated circuit is provided with high communication speed features, that is to say at least 300 kb/s in particular more than 1 Mb/s.

The parser module comprises parsing logic and parsing rules. The parsing logic is arranged to analyze the incoming flow of data to be signed. The parsing logic comprises, for example, a LEX (Lexical analyzer generator) and a YACC (Yet Another Compiler Compiler) analyzer. Advantageously, in the case of a PKI smartcards, optimized and simplified LEX and YACC analyzer can be used to increase the performance. The optimized and simplified LEX and YACC analyzer can advantageously be accelerated by hardware means. To this purpose LEX and YACC analyzer can be implemented, for example, in the form of finite state machines implemented in hardware.

The parsing rules define a security policy, that is to say the criteria for accepting the data to be signed or classifying them as potentially unsafe. The parsing rules hold the configuration data that determine which elements the parsing logic should look for when analyzing the incoming flow of data to be signed.

The parsing rules comprise a description of the key words that should be looked for in the data to be signed. The parsing rules further comprise a “grammar”. In the YACC world, “grammar” refers to the arrangement of keywords that are looked for.

In a receiving step, the data to be signed are received by the parser module.

In an analyzing step, the parser module analyzes the data to be signed against the parsing rules. More particularly, the LEX analyzer analyzes if a key word defined in the parsing rule is comprised in the data to be signed. When a keyword is found, the keyword is sent to the YACC analyzer. The YACC analyzer then tries to find a matching grammar. This does not necessarily require involvement from the smart card's Central Process Unit (CPU). The CPU is then notified when a grammar rule is met. The notification can be done, for example, by an interrupt, or by any means deemed appropriate.

If the data to be signed does not match the security policy as defined by the parsing rules, in a warning step, a warning is sent to the signature module. The signature module can then decide to reject the signature request or take any other appropriate action. The warning can be a OK/NOK notification. The warning can also be more elaborate, such as: forbidden/very dangerous/potentially dangerous for application X/safe.

The above-mentioned description concerns a signature creation device comprising a signature module arranged to sign data. The signature creation device further comprises a parser module arranged to check the data against rules. The rules are stored on the signature creation device.

The above-mentioned description illustrates rather than limits the invention. It will be evident that there are numerous alternatives, which fall within the scope of the appended claims. In this respect, the following closing remarks are made.

The parsing rules can be end-user specific and vary over time. In order to prevent an attacker from loading illegal rules, the parsing rules can be advantageously secured. To secure the parsing rules, they can be signed digitally. Post issuance loading is thus possible and secure. The signature creation device (SCD) can be arranged to reject any rule that is not signed by an authorized rule issuer or that has an invalid signature.

To a subset of the whole rules loaded on the SCD, can be associated a specific signature private key. Based on the key that is invoked, the parser will use the relevant subset.

This can be useful when dedicated keys are used (E.G. keys for internal communications, keys for external communications certified by external Certification Authorities, keys for signing purchase orders above 1M$, keys for e-mail signature etc.). Each key can be associated with a different level of trust. Certification authorities provide different classes of certificates, depending on the level of reliability of the enrollment. Is it a face to face registration, do users have to sign a document manually, to present an ID with a photograph, etc. This granularity can bring both a security and a performance benefit. Still, each key being potentially linked to several rules, the parser will often have to be able to manage several parsing operations “in parallel.” In most SCDs, the data to be signed will not be stored within the SCD and will have to be processed on the fly. Tools such as YACC use to work with several rules at the same time.

The parsing rules can also be configured by an administrator of the SCD, on behalf of the SCD user or of the SCD issuer. The administrator defines the rules that should trigger the signature rejection or warning. The administrator loads the set of rules to the SCD. He then initializes each private key's rules subset (list of rules that need to be taken into account for that key). SCDs can also be configured so that, by default, all rules are applied to all signature private keys.

Each time a new attack is found, the administrator can download an additional set of rules. When the attack has been solved and the SCD user's PC has been patched, the administrator can optionally unload the unnecessary rules (e.g. for performance reason).

For example in the case of consumer applications, the rules can be managed by the SCD holder himself. Public kiosks available in public locations with basic security (guaranteeing that the kiosk is not physically tampered with) such as post offices can be used. The kiosk can be, for example, a hardware device equipped with a touch screen and a smartcard reader, embedded in a tamper resistant body, and without input devices (no keyboard, no mouse, no CD/floppy/DVD drive, etc.). The kiosk is preferably not connected to any public network. The kiosk serves as a visual configuration tool for the cards. The kiosk enables the user to select between a predefined set of constraints that will be converted into rules by the kiosk. E.G. “don't allow purchases on such or such online store”, or “limit purchases on this store to $500 max”, or “only allow purchases on this list of stores”.

Advantageously the data to be signed can be a document following a standard template. For example, in most countries the format for filling the income tax online is well specified. The parsing mechanism of the SCD can then arranged to check selected fields within the document in a much more efficient manner than with an a priori unknown format (i.e. with much simpler rules).

The file formats that are particularly targeted are XML formats since they are very universal and could be used for lots of documents, but other standard and widespread formats could be covered (e.g. RTF and HTML), and optionally proprietary formats when there's a business for that.

As an example, when a form contains amounts of money, the rules can be initially personalized so that for certain fields it rejects amounts higher than a certain threshold (depending on the SCD owner). A predefined list of beneficiaries can also be defined so that fund transfers can only be done towards these beneficiaries.

Advantageously, as illustrated in FIG. 3, the signature module comprises a hashing module and a padding module. The likelihood of remote controlled fake signature computations is thus reduced. Thus, an attacker would have to upload the whole data to be signed on the PC, which is a more complex operation. In addition the upload can be more easily detected. Then he would have to sign that huge document in the card, which again can be detected: the smartcard reader will blink during the upload operation, which will be much longer than just sending the hash and signing it.

To better illustrate the invention, the following practical examples are given.

### EXAMPLE 1

### Corporate Badge

Employees can be asked to fill their expense reports electronically, sign them with their corporate badge and have them approved with their manager's badge. With the invention, a parsing rule can be created that defines the list of subordinates whose expenses can be signed. An unauthorized person will thus be prevented from signing the expenses of a colleague. Certain categories of expenses can also be forbidden as well. Maximum amounts allowed for each category of expense can also be defined.

In addition, organizations may want to place purchase orders electronically and digitally sign them with their employees' corporate badges. In this context, a parsing rule can be created to check, before the signature, whether the amount of a purchase order does not exceed an authorized maximum. Another parsing rule can be created to check whether the provider is one of the providers accepted by your company, etc.

The same goes for any other type of documents, for example, contracts. In general, in a company, only certain persons are allowed to sign certain types of contracts. The corporate badge of an employee can prevent him from signing a contract on behalf of your company if he is not allowed to do so. The parsing rules can rely on company's policy for contracts and check, for example, whether the documents are written according to a corporate standard template.

### EXAMPLE 2

### Fund Transfer Form

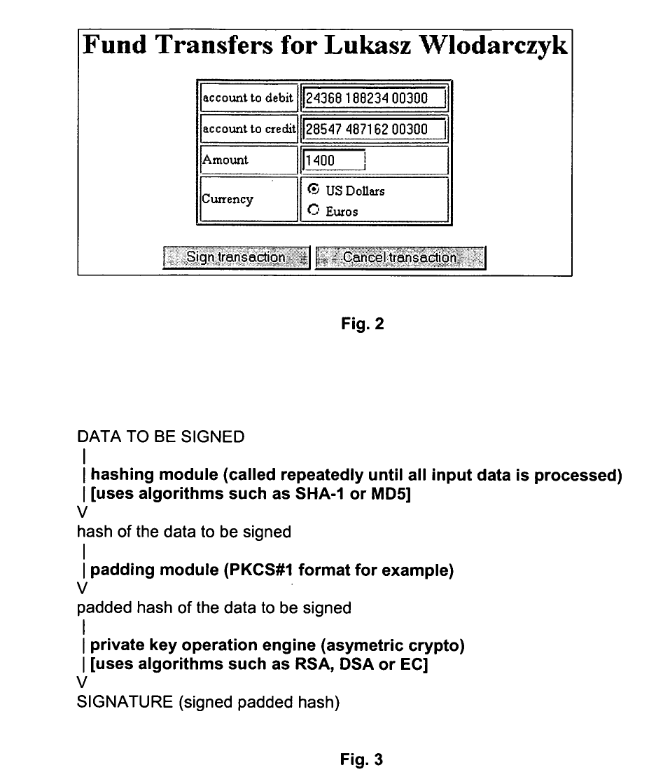

Here is the HTML source of the fund transfer form illustrated in FIG. 2:

<html>
<body>
<h1>
<center> Fund Transfers for Lukasz Wlodarczyk </center>
</h1>
<center>
<h3>
<form>

<table align = “center” border = “2”>
<tr>

<td> account to debit </td>
<td> <input align = “right”

maxlength = “18”
size = “18”
type = “text”
value = “24368 188234 00300”></td>

</tr>
<tr>

<td> account to credit </td>
<td> <input align = “right”

maxlength = “18”
size = “18”
type = “text”
value = “28547 487162 00300”></td>

</tr>
<tr>

<td> Amount </td>
<td> <input align = “right”

maxlength = “5”
size = “7”
type = “text”
value = “1400”></td>

</tr>
<tr>

<td> Currency </td>
<td> <input align = “right”

type = “radio”
checked> US Dollars <br>
<input align = “right”
type = “radio”> Euros <br> </td>

</tr>

</table> <p>
<input align = “left”

type = “submit”
value = “Sign transaction”>

<input align = “left”

type = “submit”
value = “Cancel transaction”>

</form>
</h3>
</center>
</body>
</html>

The format of the above-mentioned HTML source adheres to certain rules such as:
All HTML tags are lowercase
Paragraph marks consist of a CR followed by a LF
There are never two (or more) consecutive paragraph marks (only one is allowed)
Blank delimiters consist of a single space or of a paragraph mark followed by an arbitrary number of spaces, limited to 14 maximum. There are no tabs (they are replaced by spaces), and no spaces are allowed just before a paragraph mark
There is no blank delimiters before the initial <HTML> and after the </HTML> tags
First and Last names must be capitalized but lowercase after the initial
Etc.

The following parsing rules can be defined. To better understand, they are expressed in natural language. In practice a dense and optimized binary syntax is used:

Rule 1—Rule for checking that the document is a legitimate fund transfer document.

Key words definition:
delimiters means a single space or a paragraph mark followed by up to 14 spaces
formatting means <h1> or </h1> or <center> or </center> card_holder_name means “Lukasz Wlodarczyk”
word is a series of up to 16 lowercase or uppercase characters
label is a series of up to 5 word separated by delimiters
allowed labels is “account to debit” or “account to credit” or “Amount” or “Currency”
fields means <td> followed by label followed by </td>

Grammar:
Check that the document starts with the <html> key word, followed by delimiters, followed by the <body> key word followed by delimiters, followed by formatting, followed by “Fund Transfers for”, followed by card_holder_name.
Check that all fields contain allowed labels.
Check that the document finishes with the </body> key word, followed by delimiters, followed by the </html> key word.

Rule 2—Rule for checking that the fund transfer meets the policy defined for the cardholder.

Key words definition:
Input field is fields followed by <td> followed by anything but </td> and “value=” followed by “value=” followed by anything but </td> and “value=” followed by </td>.
Allowed account is the list of allowed bank account numbers to which the cardholder accepts to transfer funds (E.G. all accounts starting from the same bank ID as the card holder's bank, since conflicts internal to a bank can be more easily resolved, etc.).
Max amount is the maximum amount desired by the cardholder and authorized by the bank.

Grammar:
Check that the Input field following the “Amount” field contains an amount lower than Max amount.
Check that the Input field following the “account to credit” field contains an account number that is an Allowed account.

If the fund transfer form does not follow these parsing rules, the signature is likely to be rejected by the PKI smartcard.

The invention better protects sensitive parts of the data to be signed against modifications that can be highly harmful. In addition, it better protects against certain types of attacks that consist in manipulating the data to be signed in order that it displays in different manners depending on attacker's intentions.

1. A signature creation device comprising a signature module arranged to sign data, characterized in that the signature creation device comprises a parser module arranged to check the data against rules, the rules being stored on the signature creation device.

2. A signature creation device according to claim 1, wherein the signature creation device is a smartcard.

3. A signature creation device according to claim 2, wherein the smart card comprises an integrated circuit provided with high communication speed features.

4. A signature creation device according to claim 1, wherein the signature signature further comprises a hashing module and a padding module.

5. A signature creation device according to claim 1, wherein the data to be signed follow a predefined template.

6. A signature creation device according to claim 5, wherein the data to be signed are in an XML format.

7. A signature creation device according to claim 5, wherein the data to be signed are in an HTML format.

8. A signature creation device according to claim 5, wherein the data to be signed are in an RTF format.

9. Method of signing data using a signature creation device, the signature creation device comprising a signature module and a parser module, the method comprising an analyzing step, in which the parser module analyzes the data against rules stored within the signature creation device.
